(19) United States
(12) Patent Application Publication
(10) Pub. No.: US 2014/0004457 A1
(43) Pub. Date: Jan. 2, 2014

(54) POLYMERIZATION TONER FOR ELECTROSTATIC DEVELOPING

(71) Applicants: Jae Bum Park, Daejeon (KR); Young Jae Kwon, Daejeon (KR); Dong Woo Kim, Daejeon (KR); Dae Woong Choi, Daejeon (KR)

(72) Inventors: Jae Bum Park, Daejeon (KR); Young Jae Kwon, Daejeon (KR); Dong Woo Kim, Daejeon (KR); Dae Woong Choi, Daejeon (KR)

(73) Assignee: SAMSUNG FINE CHEMICALS CO., LTD., Ulsan (KR)

(21) Appl. No.: 13/997,580

(22) PCT Filed: Dec. 21, 2011
(86) PCT No.: PCT/KR2011/009946

§ 371 Date: Sep. 16, 2013

(30) Foreign Application Priority Data
Dec. 24, 2010 (KR) 10-2010-0134754

(51) Int. Cl. G03G 9/16; G03G 13/16

(52) U.S. Cl. CPC G03G 9/16; G03G 13/16
USPC 430/105; 430/125.3

(57) ABSTRACT

A polymerization toner having superior chargeability and storage stability is provided. The polymerization toner includes a binder resin and a colorant, wherein the binder resin has a dielectric constant ranging from 2.8 to 3.7.

### TECHNICAL FIELD

The present invention relates to a polymerization toner for developing an electrostatic image, a developer for forming an electrophotographic image, including the same, and a method of forming an electrophotographic image using the toner, and more particularly, to a polymerization toner for developing an electrostatic image, having superior chargeability and storage stability, a developer for forming an electrophotographic image, including the same, and a method of forming an electrophotographic image using the toner.

### BACKGROUND ART

There have been known many electrophotographic methods in which an electrostatic latent image is formed of a photoconductive material on a photosensitive member by various means, is developed by a toner to form a visible image, a toner image is transferred onto a transfer receiving medium such as paper, and a fixed image is formed on the transfer receiving medium by applying heat and/or pressure.

These days, an image forming apparatus using such electrophotographic methods includes various apparatuses such as a printer and a facsimile. Such image forming apparatuses need a developing method having higher resolution and sharpness, and for this purpose, toners having a small particle size and a narrow particle size distribution have been developed.

As the methods of producing a toner having a narrow particle size distribution and a superior circularity at a low cost, an emulsion polymerization method, a suspension polymerization method, or the like have been known. However, when the toner particle size is small, an aggregation force between particles may increase, a transfer from a photoreceptor may not be good, and an image omission may occur.

In order to save the printing cost, it is necessary to decrease a toner attachment amount, and for this, when the usage amount of a colorant increases, the dispersion of the colorant is not good and thus the image omission is more serious.

Japanese Patent Application Laid-Open Publication No. 2006-91096 discloses an electrostatic charge image developing black toner, which is prepared by a wet granulation method, has a dielectric constant ∈′ of 2.6 to 3.2, a coating weight of 4 g/m², an image reflection density (RD) of 1.2 or more, and 3 to 7 μm volume average particle size, keeps a predetermined image density even when the toner coating weight is decreased, and has excellent transcription property and circularity of the toner particles.

However, the toner is limited to a black toner, and does not have satisfactory chargeability and storage stability of toner.

### DETAILED DESCRIPTION OF THE INVENTION

### Technical Problem

An embodiment of the present invention provides a polymerization toner for developing an electrostatic image, having superior chargeability and storage stability, a low printing cost, and high image quality.

An embodiment of the present invention also provides an electrostatic image developer including the polymerization toner.

An embodiment of the present invention also provides a method of forming an electrophotographic image using the electrostatic image developer.

### Technical Solution

According to an aspect of the present invention, there is provided a polymerization toner including:

a binder resin and a colorant, wherein the binder resin has a dielectric constant ranging from 2.8 to 3.7.

In an embodiment of the present invention, the polymerization toner may be a color toner.

In an embodiment of the present invention, the polymerization toner may be a black toner.

According to another aspect of the present invention, there is provided an electrostatic image developer including:

the polymerization toner; and

a carrier.

According to another aspect of the present invention, there is provided a method of forming an electrophotographic image, the method including:

adhering toner to a photoreceptor surface with an electrostatic latent image thereon to form a toner image, and transferring the toner image onto a transfer medium.

Hereinafter, the present invention will be described in more detail.

An electrostatic image developing toner according to an aspect of the present invention is a polymerization toner including a binder resin and a colorant, wherein the binder resin has a dielectric constant ranging from about 2.8 to about 3.7.

Since the toner according to an embodiment of the present invention includes the binder resin having a dielectric constant within the above-mentioned range, the chargeability and storage stability of the resultant toner are superior.

The polymerization toner may be a color toner or a black toner.

When the toner is a color toner, that is, a cyan toner, a yellow toner, or a magenta toner, the dielectric constant of the polymerization toner satisfies Equation (1):

0.8 B≦dielectric constant of polymerization toner≦1.2 B (1),

wherein, B indicates the dielectric constant of the binder resin.

When the toner is a black toner, the dielectric constant of the polymerization toner satisfies Equation (2):

1.1 B≦dielectric constant of polymerization toner≦1.4 B (2),

wherein, B indicates the dielectric constant of the binder resin.

In an embodiment of the present invention, a method of measuring the dielectric constant of the binder resin and the toner is not particularly limited, and for example, the dielectric constant of the binder resin and the toner may be measured under a condition that a toner sample is formed in a plate shape at a pressure of 500 kg/cm² in an environment of 25° C. and 50% humidity, the formed toner sample is installed between electrodes, and a voltage of 5 V and a frequency of 1 GHz are applied by using an Analyzer E4991 Impedance Analyzer (Agilent Technologies).

Since the toner of an embodiment of the present invention has a dielectric constant within the above-mentioned range, the static and storage stability are superior.

The binder resin contained in the toner of an embodiment of the present invention may be prepared by polymerizing one or more types of polymeric monomers selected from a vinyl-based monomer, a polar monomer having a carboxylic group, a monomer having an unsaturated ester group, and a monomer having a fatty acid group. Concrete examples of the polymerizable monomer may include: styrene-based monomers such as styrene, vinyl toluene, and α-methyl styrene; acrylic acid or methacrylic acid; derivatives of (meth)acrylates such as methyl acrylate, ethyl acrylate, propyl acrylate, butyl acrylate, 2-ethylhexyl acrylate, dimethylamino ethyl acrylate, methyl methacrylate, ethyl methacrylate, propyl methacrylate, butyl methacrylate, 2-ethyl hexyl methacrylate, dimethylaminoethyl methacrylate, acrylonitrile, methacrylonitrile, acrylamide, and metacryl amide; ethylenically unsaturated mono-olefins such as ethylene, propylene, and butylene; halogenated vinyls such as vinyl chloride, vinylidene chloride, and vinyl fluoride; vinyl esters such as vinyl acetate and vinyl propionate; vinyl ethers such as vinyl methyl ether and vinyl ethyl ether; vinyl ketones such as vinyl methyl ketone and methyl isopropenyl ketone; and nitrogen-containing vinyl compounds such as 2-vinylpyridine, 4-vinylpyridine, and N-vinyl pyrrolidone, but they are not limited thereto.

Generally, a polymerization initiator may be used to initiate the polymerization. Examples of the polymerization initiator are a benzoyl peroxide-based polymerization initiator and an azo-based polymerization initiator.

A portion of the binder resin may be further subjected to a reaction with a cross-linking agent, such as an isocyanate compound and an epoxy compound.

When the binder resin is a polyester resin, the polyester resin may be prepared by polycondensation of an acid component such as a polyvalent carboxylic acid, and an alcohol component such as a polyhydric alcohol.

Concrete examples of the polyvalent alcohol component may include polyoxyethylene-(2,0)-2,2-bis(4-hydroxyphenyl)propane, polyoxypropylene-(2,0)-2,2-bis(4-hydroxyphenyl)propane, polyoxypropylene-(2,2)-polyoxyethylene-(2,0)-2,2-bis(4-hydroxyphenyl)propane, polyoxyethylene-(2,3)-2,2-bis(4-hydroxyphenyl)propane, polyoxypropylene-(6)-2,2-bis(4-hydroxyphenyl)propane, polyoxypropylene-(2,3)-2,2-bis(4-hydroxyphenyl)propane, polyoxypropylene-(2,4)-2,2-bis(4-hydroxyphenyl)propane, polyoxypropylene-(3,3)-2,2-bis(4-hydroxyphenyl)propane, polyoxyethylene-(6)-2,2-bis(4-hydroxyphenyl)propane, ethylene glycol, 1,3-propylene glycol, 1,2-propylene glycol, 1,4-butylene glycol, 1,3-butylene glycol, glycerol, and polyoxypropylene. Concrete examples of the polyvalent carboxylic acid component include aromatic polyvalent acids, and/or alkyl esters thereof typically used for preparing a polyester resin. Examples of the aromatic polyvalent acids may include terephthalic acid, isophthalic acid, trimellitic acid, pyromellitic acid, 1,2,4-cyclohexanetricarboxylic acid, 2,5,7-naphthalene tricarboxylic acid, 1,2,4-naphthalene tricarboxylic acid, 1,2,5-hexanetricarboxylic acid, 1,2,7,8-octanetetracarboxylic acid, or alkyl esters thereof, and examples of the alkyl group may include a methyl group, an ethyl group, a propyl group, a butyl group, and the like. The aromatic polyvalent acids and alkyl esters thereof may be used alone or in combination of two or more kinds thereof.

The polyester resin may have an acid value in the range of about 5 to about 100, for example, in the range of about 10 to about 20.

The polyester resin used in an embodiment of the present invention may have a weight-average molecular weight in the range of about 5,000 to about 50,000. When the weight-average molecular weight is less than 5,000, it has a bad influence on the preservability and fixability of toner, and when the weight-average molecular weight is more than 50,000, it has a bad influence on the fixability.

Also, the polyester resin may have a polydispersity index (PDI) in the range of about 2 to about 10, and a peak molecular weight (Mp) in the range of about 1,000 to about 10,000 as measured by using gel permeation chromatography (GPC). In an embodiment of the present invention, the Mp in the GPC is the molecular weight determined from the peak value of the elution curve obtained by GPC measurement. The measurement conditions for GPC were as follows:

Apparatus: Toyo Soda Manufacturing Co., Ltd., HLC8020

Column: Toyo Soda Manufacturing Co., Ltd., TSKgelGMHXL (Column size: 7.8 mm (ID)×30.0 cm (L)), three columns linked in series

Oven Temperature: 40° C.

Eluent: THF

Mp was determined by drawing a calibration curve for standard polystyrene from the retention time corresponding to the peak value of the obtained elution curve.

The standard polystyrene samples used for the calibration curve were TSK standard, A-500 (molecular weight: 5.0×10²), A-2500 (molecular weight: 2.74×10³), F-2 (molecular weight: 1.96×10⁴), F-20 (molecular weight: 1.9×10⁵), F-40 (molecular weight: 3.55×10⁵), F-80 (molecular weight: 7.06×10⁵), F-128 (molecular weight: 1.09×10⁶), F-288 (molecular weight: 2.89×10⁶), F-700 (molecular weight: 6.77×10⁶), and F-2000 (molecular weight: 2.0×10⁷), by Toyo Soda Manufacturing Co., Ltd.

Also, the peak value of the elution curve is the point where the elution curve is a maximum, and where two maximum points exist, it is the maximum value of the elution curve. The eluent is not particularly limited and may be any solvent that dissolves the polyester resin, such as chloroform, instead of THF.

The glass transition temperature of the polyester resin may be in the range of about 40 to about 80° C., for example in the range of about 50 to about 75° C. When the glass transition temperature is lower than 40° C., a toner formed by using the polyester resin particles may cause a drawback in the storage stability. When the glass transition temperature exceeds 80° C., offset may easily occur and be serious in color printing.

The polyester resin may not contain a sulfonic acid group.

The colorant contained in the toner may be used in the form of a pigment itself, or alternatively, in the form of a pigment master batch in which the pigment is dispersed in a resin.

The pigment may be selected from pigments that are commonly and commercially used, such as a black pigment, a cyan pigment, a magenta pigment, a yellow pigment, and a mixture thereof.

The amount of the colorant may be sufficient to color the toner and form a visible image by development, for example, in the range of about 1 to about 20 parts by weight based on 100 parts by weight of the binder resin.

The toner may further include additives in addition to the binder resin and the colorant. The additives may include a releasing agent such as wax, a charge control agent, or the like.

Wax improves fixability of a toner image. Examples of the wax include polyalkylene wax such as low molecular weight polypropylene and low molecular weight polyethylene, ester wax, carnauba wax, and paraffin wax. The amount of the wax contained in toner may be in a range of about 0.1 parts by weight to about 30 parts by weight based on 100 parts by weight of the entire toner composition. If the amount of the wax is less than 0.1 parts by weight, oil-less fixing of toner particles, in which toner particles are fixed without using oil, may not be performed. On the other hand, if the amount of the wax is greater than 30 parts by weight, toner may be agglomerated while it is stored.

Also, the additives may further include external additives. The external additives are used to improve fluidity of the toner or control charge properties of the toner. Examples of the external additives include large particle size silica, small particle size silica, and polymer beads.

The toner according to the current embodiment may be prepared by using various methods. In other words, any method of preparing the toner having the above-mentioned properties which is commonly used in the art may be used.

For example, the toner particles may be prepared by using the following method: An agglomerating agent is added to a mixture including a latex dispersion, a colorant dispersion, and a wax dispersion. Then, the mixture is homogenized and aggregated to prepare toner particles. That is, the latex dispersion, the colorant dispersion, and the wax dispersion are put in a reactor and mixed. Then, the agglomerating agent is added thereto, and the mixture is homogenized at a stirring line speed of about 1.0 to about 2.0 m/s at a temperature of about 20 to about 30° C. for 10 to 100 minutes while controlling the pH in the range of about 1.5 to about 2.3. Then, the reactor is heated to a temperature in the range of about 48 to about 53° C. and stirred at a stirring line speed of 1.0 to 2.5 m/s to perform aggregation. The aggregated toner particles are fused, cooled, and dried to obtain desired toner particles. The dried toner particles are treated with external additives using, for example, silica or the like to adjust charge quantity and then obtain desired toner for a laser printer.

The toner particles according to an embodiment of the present invention may have a core-shell structure. The toner having the core-shell structure may be prepared by using a method including: preparing a primary aggregated toner by adding an agglomerating agent into a mixture of a latex dispersion for a core, a colorant dispersion, and a wax dispersion, and homogenizing and aggregating the mixture; forming a shell layer by adding a latex for a shell to the primary aggregated toner; and fusing the structure.

Also, the toner according to an embodiment of the present invention may be prepared by a method including: preparing a polyester resin dispersion by adding a polyester resin and an organic solvent to a polar solvent containing a surfactant and a dispersion stabilizer while stirring the mixture and then heating the mixture; mixing a colorant dispersion and a wax dispersion with the polyester resin dispersion; homogenizing the mixture by adding an agglomerating agent to the mixture; aggregating the homogenized mixture; and fusing the aggregated toner particles.

The process may be simplified and the process time may be shortened by preparing the polyester resin dispersion in a single reactor. In addition, since the dispersion stabilizer allows the dispersion to be uniformly neutralized, the size of the particles in the dispersion may be uniform.

Further, unlike the related art method in which a polyester resin dispersion is prepared by completely dissolving a polyester resin in an organic solvent and mixing the dissolved polyester resin with the remaining components, the polyester resin is added sequentially in the above-mentioned order to easily remove the organic solvent while the dispersion is prepared.

The polar solvent containing the surfactant and the dispersion stabilizer may be prepared by adding the surfactant and the dispersion stabilizer to a polar solvent sequentially or simultaneously.

It is desirable to add the surfactant, the dispersion stabilizer, the polyester resin, and the organic solvent to the polar solvent sequentially in the stated order.

In the preparation of the polyester resin dispersion, the heating may be performed at a temperature above the boiling point of the organic solvent. The heating may be performed for about 3 hours to about 15 hours.

The particles in the polyester resin dispersion may have a size in the range of about 50 nm to about 300 nm.

Examples of the polar solvent may include water, methanol, ethanol, butanol, acetonitrile, acetone, ethyl acetate, and the like, for example, the polar solvent may be water. The amount of the polar solvent may be about 150 parts by weight to about 500 parts by weight based on 100 parts by weight of the polyester resin.

The organic solvent used in the polyester resin dispersion may include at least one selected from the group consisting of dimethyl ether, diethyl ether, 1,1-dichloroethane, 1,2-dichloroethane, dichloromethane, and chloroform, but it is not limited thereto. The organic solvent may be contained in the amount of about 150 parts by weight to about 500 parts by weight based on 100 parts by weight of the polyester resin.

The surfactant used in the polyester resin dispersion may be an anionic surfactant, and may be used in the amount of about 1 part by weight to about 4 parts by weight based on 100 parts by weight of the polyester resin.

The dispersion stabilizer used in the polyester resin dispersion may include a monovalent cation-containing base, for example, at least one selected from the group consisting of potassium hydroxide, sodium hydroxide, sodium carbonate, sodium bicarbonate, lithium hydroxide, potassium carbonate, ammonia, triethylamine, triethanolamine, pyridine, ammonium hydroxide, diphenylamine and derivatives thereof, and for example, the dispersion stabilizer may be sodium hydroxide or potassium hydroxide.

The amount of the dispersion stabilizer is associated with the acid value of the polyester resin, and the higher the acid value the higher the amount of the dispersion stabilizer is, so that it is possible to prepare a dispersion having a narrow particle size distribution. The dispersion stabilizer may be added in an amount of about 2 to about 3 equivalents based on the acid value of the polyester resin.

The colorant dispersion may be prepared by dispersing a colorant in water by using a dispersant such as a surfactant. Where the colorant is dispersed in water, an anionic surfactant and a non-ionic surfactant may be used as the dispersant, for example, a non-ionic surfactant may be used. The use of the dispersant allows pigment to be easily dispersed in water and decreases the particle size of dispersed pigment in toner, so that a toner having superior characteristics may be prepared. An unnecessary dispersant may be removed by a subsequent washing process.

The colorant may be selected from pigments that are commonly and commercially used, such as a black pigment, a cyan pigment, a magenta pigment, a yellow pigment, and a mixture thereof.

The amount of the colorant may be sufficient to color the toner and form a visible image by development, for example, in the range of about 3 to about 15 parts by weight based on 100 parts by weight of the polyester resin. When the amount of the colorant is less than 3 parts by weight, a coloring effect may be insufficient, and when the amount of the colorant is greater than 15 parts by weight, electric resistance of the toner is reduced, and thus a sufficient friction charging amount may not be obtained and pollution may occur.

The wax dispersion may be prepared by dispersing natural or synthetic wax in water.

Wax used herein may be any one of various known waxes. For example, natural wax, such as carnauba wax or rice wax, synthetic wax, such as polypropylene wax, polyethylene wax, or the like, petroleum based wax, such as montan wax or the like, alcohol-based wax, ester-based wax, or the like may be used. The wax may be used alone or in combination of at least two of these.

When wax is dispersed in water, a surfactant or a dispersion stabilizer may be used, and a dispersing device, such as a high-pressure or high-speed homogenizer, or the like may be used to prepare a dispersion. The amount of the wax may be in a range of about 0.5 to about 20 parts by weight, for example, about 1 to about 10 parts by weight, based on 100 parts by weight of the polyester resin.

The respective dispersions prepared in the dispersion preparing process are mixed and homogenized by adding an agglomerating agent and an acid while stirring the mixture, and then the toner particles are aggregated.

The aggregation process may be performed at room temperature. Alternatively, the aggregation process may be performed while heating to near a glass transition temperature Tg of the polyester resin. The stirring of the dispersions may be performed by using a stirrer and a mechanical shear force to prepare agglomerated particles with a uniform size and shape.

The agglomerating agent used herein may be any one of various known agglomerating agents. For example, an organic material containing ions having an opposite polarity to an electrolyte or a pigment may be used. For example, sodium chloride (NaCl), which is easily washed by pure water and has high solubility to water, may be used as the agglomerating agent. The total amount of the agglomerating agent may be in the range of about 0.3 to about 6 wt %, for example, in the range of about 1.0 to about 5 wt % based on the entire solid component. When the amount of the agglomerating agent is less than 0.3 wt %, aggregation may not easily occur, and when the amount of the agglomerating agent is greater than 6 wt %, the aggregated particles may be too large.

While the amount of the agglomerating agent is about 0.3 to about 6 parts by weight based on the solid component of the raw materials used in the aggregation process, since the dispersion stabilizer used in preparation of the polyester resin dispersion plays a role to assist the aggregation in the aggregation process, the dispersion stabilizer may be added.

In the aggregation process, pH may be adjusted by adding an acid, for example, to the range of about 4.5 to about 6.5.

The aggregation process may be performed by stirring the reaction liquid at a rate of about 1.0 to about 7.0 m/sec in the temperature range of about 40 to about 60° C.

To freeze the aggregation, the temperature of the reaction liquid is maintained and the pH is increased up to 10.

To increase the pH, an inorganic base such as NaOH, KOH, or LiOH is added.

Then, a mixed solution, including toner particles, is heated to homogenize the particle size and shape of the aggregated toner particles. The particle size of the toner particles may be adjusted in the range of about 1 to about 20 μm by heating the mixed solution at a temperature that is not less than the glass transition temperature Tg of the binder resin, thereby obtaining toner particles having an almost uniform particle size and shape.

The surface property of the toner particles may be improved by heating the particles at a temperature that is not less than the glass transition temperature Tg of the binder resin. Before heating the toner particles at a temperature that is not less than the glass transition temperature Tg of the binder resin, a polyester resin dispersion or a polystyrene butylacrylate latex may be added to enclose the toner particles formed in the aggregation process and thus prevent the pigment or wax contained in the toner particles from being released to the outside, thereby hardening the toner. At this time, the polyester resin dispersion or polystyrene butylacrylate latex added may be a resin dispersion having the same physical properties (Tg, molecular weight) as polyester resin dispersion used in the previous step, or having higher glass transition temperature and molecular weight. When a resin dispersion having a higher glass transition temperature and molecular weight is used, the glass transition temperature may be in the range of about 60 to about 85° C. and the molecular weight may be in the range of about 10,000 to about 300,000. While the toner particles formed in the aggregation process are enclosed with the added resin dispersion, the particle size may be increased. To prevent such an increase, the fusing process may be performed by adding a surfactant or adjusting pH, and increasing the temperature to a temperature that is not less than the glass transition temperature of the polyester resin.

The toner particles obtained in the fusing process are then washed with water and dried. In this process, a mixed solution including toner is cooled to room temperature and filtered to remove a filtrate, and then the toner is washed with water. Washing may be performed with pure water having a conductivity of not more than 10 μS/cm, and the washing may be continuously performed until the conductivity of the water after washing the toner reaches 5 μS/cm or less. The washing of the toner with pure water may be a batch-type process or a continuous-type process. The washing of the toner with pure water may be performed to remove unnecessary components, such as impurities that may affect a chargeability of the toner and an unnecessary agglomerating agent that did not participate in the aggregation.

When an inorganic salt of a monovalent metal is used as the agglomerating agent, toner particles are not re-aggregated due to reactivation of the inorganic salt according to a pH variation in the washing process, and since the inorganic salt of the monovalent metal has a remarkably higher solubility to water than an inorganic salt of a polyvalent metal, it may be easily removed in the washing and thus the amount of the inorganic salt remaining in the toner is remarkably lowered, so that the melting viscosity of the toner particles are not increased to improve the fusing characteristic.

Following the washing process, the toner is dried by using a fluidized bed dryer, a flash jet dryer, or the like. Also, an external additive may be further added to the dried toner.

According to another aspect of the present invention, there is provided an electrostatic image developer including the above-mentioned toner. The electrostatic image developer may further include as a carrier at least one selected from the group consisting of an insulator-coated ferrite, an insulator-coated magnetite, and an insulator-coated iron powder.

According to another aspect of the present invention, there is provided a method of forming an electrophotographic image using the above-mentioned toner.

The method includes adhering the toner or the electrostatic image developer on a surface of a photoreceptor on which an electrostatic latent image is formed, to form a toner image; and transferring the toner image onto a transfer medium.

The toner or the electrostatic developer according to an embodiment of the present invention is used in an apparatus for forming an electrophotographic image, such as a laser, a printer, a copier, a facsimile, or the like.

### Advantageous Effects

A polymerization toner of the present invention has superior chargeability and storage stability, and enables to obtain a high quality picture at a small printing cost.

### DESCRIPTION OF THE DRAWINGS

FIG. 1 is a graph showing a dielectric constant of toners according to Examples and Comparative Examples.

FIG. 2 is a graph showing charge quantity of toners according to Examples and Comparative Examples.

FIG. 3 is a graph showing charge speed of toners according to Examples and Comparative Examples.

### BEST MODE

Hereinafter, embodiments of the present invention are described in detail with examples, but the present invention is not limited to the examples.

Average Particle Size Measurement

An average particle size of toner was measured by using a Multisizer 3 Coulter Counter. An aperture of 100 μm was used in the Multisizer 3 Coulter Counter, an appropriate amount of a surfactant was added to 50 to 100 ml of ISOTON-II (Beckman Coulter Inc.) as an electrolyte, and 10 to 15 mg of a sample to be measured was added thereto, and the resultant was dispersed in a ultrasonic dispersing apparatus for 5 minutes to prepare a sample.

Glass Transition Temperature (Tg, ° C.) Measurement

A glass transition temperature Tg of a sample was measured using a differential scanning calorimeter (DSC) (manufactured by Netzsch Co.) by heating the sample from 20° C. to 200° C. at a heating rate of 10° C./min, rapidly cooling the sample to a cooling rate of 10° C. at 20° C./min, and heating the sample at a heating rate of 10° C./min.

Acid Value Measurement

An acid value (mgKOH/g) was measured by dissolving a resin in dichloromethane, cooling the solution, and titrating the solution with a 0.1 N KOH methyl alcohol solution.

Molecular Weight Measurement

A molecular weight was measured by using GPC (Waters Alliance GPC 2000 Systems). Tetrahydrofuran (THF) was used as a solvent, and a calibration curve of molecular weight was obtained by using standard polystyrene.

### Example 1

(Preparation of Latex for Core and Shell)

A 30 L reactor equipped with a stirrer, a thermometer, and a condenser was installed in an oil bath in which oil is a heat transfer medium. 6,600 g of distilled water and 32 g of a surfactant (Dowfax 2A1) were added to the reactor, and the reactor was heated to 70° C. and stirred at 100 rpm. Then, an emulsion mixture, including monomers, i.e., 8,380 g of styrene, 3,220 g of butyl acrylate, 370 g of 2-carboxyethyl acrylate, and 226 g of 1,10-decanediol diacrylate, 5,075 g of distilled water, 226 g of the surfactant (Dowfax 2A1), 530 g of polyethylene glycol ethyl ether methacrylate, as a macro monomer, and 188 g of 1-dodecanethiol, as a chain transfer agent, was stirred at 400 rpm to 500 rpm for 30 minutes using a disc-type impeller. Then, the emulsion mixture was gradually added to the reactor for 1 hour. The reactor was maintained for about 8 hours and gradually cooled to room temperature to complete the reaction.

The glass transition temperature Tg of the binder resin measured by using a DSC was 62° C. The number-average molecular weight of the binder resin measured by GPC using polystyrene as a standard sample was 50,000. The dielectric constant of the binder resin, measured by an impedance analyzer, was 2.8.

(Preparation of Pigment Dispersions 1 to 4)

540 g of a cyan pigment (Dainichiseika Color & Chemicals Mfg. Co., Ltd., Japan, ECB303), 27 g of a surfactant (Dowfax 2A1), and 2,450 g of distilled water were added to a 3 L reactor equipped with a stirrer, a thermometer, and a condenser, and the reactor was slowly stirred for about 10 hours to obtain a pre-dispersion. The pre-dispersion was further dispersed using a beads mill (Netzsch, Germany, Zeta RS) for 4 hours. As a result, a cyan pigment dispersion 1 was obtained.

Then, the particle size of the cyan pigment was measured using by a Multisizer 2000 (Malvern Instruments, Ltd.), and a volume-average particle diameter (D50(v)) was 170 nm. In this regard, when the volume of the particles is accumulated from particles of the smallest size in ascending order until the accumulated volume reaches 50% of the total volume of the particles, an average particle size of the accumulated particles corresponding to 50% of the total volume of the particles is defined as D50(v).

Pigment dispersions 2 to 4 were prepared by the same method as the preparation process of the pigment dispersion 1 except for using 3.7 kg of a yellow pigment (Clariant Corporation, PY74), 2.3 kg of each magenta pigment (Clariant Corporation, E02 and Sanyo Chemical Industries Ltd., PR-269), and 3.5 kg of a black pigment (Cabot Corporation, Regal 330) instead of the cyan pigment.

(Preparation of Wax Dispersion)

65 g of a surfactant (Dowfax 2A1), and 1,935 g of distilled water were added to a 5 L reactor equipped with a stirrer, a thermometer, and a condenser, and 1,000 g of wax (NOF Corporation, Japan, WE-5) was added to the reactor while slowly stirring the reactor at a high temperature for about 2 hours. The wax was dispersed for 30 minutes using a homogenizer (IKA, T-45). As a result, a wax dispersion was obtained.

Then, the particle size of the wax was measured by using a Multisizer 2000 (Malvern Instruments, Ltd.), and D50(v) was 320 nm.

(Preparation of Toner Particles)

13,881 g of the latex for a core, 2,238 g of the colorant dispersion, and 2,873 g of the wax dispersion were added to a 70 L reactor, and the mixture was mixed at room temperature for about 15 minutes at 1.21 m/s. 5,760 g of a solution including poly silicato iron (PSI) and nitric acid (PSI/1.88% HNO3=½), as an agglomerating agent, was added to the reactor, and then the mixture was homogenized using a homogenizer (IKA, T-45) while stirring the reactor at 25° C. at 50 rpm (at a stirring line speed of 1.79 m/sec) for 30 minutes while controlling the pH in the range of 1.3 to 2.3. After stirring the reactor for 30 minutes, the temperature of the reactor was increased to 51° C. and stirred at 2.42 m/s using a pitched paddle-type impeller having a diameter of 0.30 m and a height of 0.07 m until the D_{50,v}, was in the range of 6.2 μm to 6.4 μm, and 5,398 g of the latex for a shell was added thereto for about 20 minutes. The reactor was stirred until an average particle size of the toner particles was in the range of 6.7 μm to 6.9 μm. A 4% sodium hydroxide aqueous solution was added to the reactor, and the reactor was stirred at 1.90 m/s until the pH reached 4 and at 1.55 m/s until the pH reached 7.0. While maintaining the stirring speed, the reactor was heated to 96° C. to fuse the toner particles. When circularity measured by using an FPIA-3000 (Sysmex Co., Japan) was 0.980, the reactor was cooled to 40° C., and the pH of the mixture was adjusted to 9.0. Then, the toner particles were isolated using an SUS sieve (pore size: 16 μm) and cleaned four times using distilled water. The pH of the toner particles was adjusted to 1.5 by using a 1.88% nitric acid aqueous solution, and the toner particles were cleaned. The toner particles were cleaned four times with distilled water to remove a surfactant or the like. Then, the cleaned toner particles were dried in a fluidized bed dryer at 40° C. for 5 hours to obtain dried toner particles.

### Example 2

(Synthesis of Polyester Resin)

A 3 L reactor equipped with a stirrer, a nitrogen gas inlet, a thermometer, and a cooler was installed in an oil bath in which oil is heat medium. 45 g of terephthalic acid, 39 g of isophthalic acid, 75 g of 1,2-propylene glycol, and 3 g of trimellitic acid were added to the reactor. Then, dibutyl tin oxide was added thereto as a catalyst at a ratio of 500 ppm with respect to the total weight of the monomers. Then, the reactor was heated to 150° C. while stirring the mixture of the reactor at a speed of 150 rpm. The reaction was maintained at the same temperature for about 6 hours, and the reactor was heated to 220° C. The pressure of the reactor was reduced to 0.1 torr in order to remove byproducts, and the reactor was maintained at the same pressure for 15 hours to complete the reaction. As a result, a polyester resin was obtained.

Glass Transition Temperature (Tg, ° C.) Measurement

A glass transition temperature Tg of a sample was measured by using a DSC (manufactured by Netzsch Co.) by heating the sample from 20° C. to 200° C. at a heating rate 10° C./min, rapidly cooling the sample to 10° C. at a cooling rate 20° C./min, and heating the sample at a heating rate 10° C./min.

Acid Value Measurement

An acid value (mgKOH/g) was measured by dissolving a resin in dichloromethane, cooling the solution, and titrating the solution with a 0.1 N KOH methyl alcohol solution.

Measurement of Weight-Average Molecular Weight and Mp

A weight-average molecular weight of the binder resin was measured by GPC using a calibration curve for standard polystyrene samples.

A max peak position (Mp) was obtained by GPC using standard polystyrene conversion from the retention time corresponding to the peak value of the obtained elution curve. Also, the peak value of the elution curve is the point where the elution curve is a maximum, and where two maximum points exist, it is the maximum value of the elution curve. Also, the signal strength of the GPC curve at a peak molecular weight (I(Mp)) and the signal strength of the GPC curve at a molecular weight 100,000 (I(M100,000)) are, respectively, the difference between the baseline signal strength and the signal strength at a peak molecular weight and the difference between baseline signal strength and the signal strength at a molecular weight 100,000, and they are represented as potentials (mV).

Apparatus: Toyo Soda Manufacturing Co., Ltd., HLC8020

Column: Toyo Soda Manufacturing Co., Ltd., TSKgelGMHXL (Column size: 7.8 mm (ID)×30.0 cm (L)), three columns connected in series

Oven Temperature: 40° C.

Eluent: THF

Sample Concentration: 4 mg/10 mg

Filtering Condition Sample solution was filtered by a 0.45 μm Teflon (Registered Trademark) membrane filter

Flow Rate: 1 ml/min

Injected Amount: 0.1 ml

Detector: RI

Standard polystyrene samples used for drawing the calibration curve: TSK standard, A-500 (molecular weight: 5.0×10²), A-2500 (molecular weight: 2.74×10³), F-2 (molecular weight: 1.96×10⁴), F-20 (molecular weight: 1.9×10⁵), F-40 (molecular weight: 3.55×10⁵), F-80 (molecular weight: 7.06×10⁵), F-128 (molecular weight: 1.09×10⁶), F-288 (molecular weight: 2.89×10⁶), F-700 (molecular weight: 6.77×10⁶), and F-2000 (molecular weight: 2.0×10⁷), by Toyo Soda Manufacturing Co., Ltd

The glass transition temperature Tg, the acid value, the weight-average molecular weight, and the Mp of the obtained polyester resin were 66° C., 11 mgKOH/g, 18,000, and 5100, respectively, and T_{1/2} was 125° C. The dielectric constant of the binder resin, measured by an impedance analyzer, was 3.7.

(Preparation of Polyester Resin Dispersion)

46 g of 4 wt % sodium hydroxide solution (2.5 equivalents based on the acid value of polyester resin) as a dispersion stabilizer, 6.67 g of a surfactant (Dowfax made by Dow corning, 1 wt % based on the weight of polyester resin), and 958 g of water were added to a 3 L reactor equipped with a thermometer and an impeller type stirrer. 300 g of a solid polyester resin and 500 g of methyl ethyl ketone were added thereto, the mixture was refluxed for 1 hour at 70° C., and the mixture was nitrogen-purged for 4 hours or more at 80° C. to remove an organic solvent. As a result, a polyester resin dispersion was obtained.

(Preparation of Pigment Dispersions 1 to 4)

3 kg of a cyan pigment (Dainichiseika Color & Chemicals Mfg. Co., Ltd., ECB303) was added to a 20 L reactor, 11.5 kg of distilled water, and 0.6 kg of hydroxypropylmethyl cellulose acetate phthalate (Samsung Fine Chemicals Co., Ltd., AnyCoat-P) were further added thereto, and the reactor was stirred at a speed of 50 rpm. Then, the mixture was transferred to a ball mill type reactor to perform a pre-dispersion. As a result of the pre-dispersion, a cyan pigment dispersion having a volume-average particle diameter (D50(v)) of 3.4 μm (measured by a multisizer coulter counter of Beckman Coulter Inc.) was obtained. Then, the contents in the reactor were subject to a high dispersion at a pressure of 1,500 bar by using an Ultimaizer system (Amstec Ltd., Model HJP25030). As a result of the high dispersion, a pigment dispersion 1 dispersed in a nano size and having a volume-average particle diameter (D50(v)) of 150 nm (measured by Microtrac 252 of Microtrac Inc.) was obtained.

Pigment dispersions 2 to 4 were prepared by the same method as the preparation process of the pigment dispersion 1 except for using 3.7 kg of a yellow pigment (Clariant Corporation, PY74), 2.3 kg of each magenta pigment (Clariant Corporation, E02 and Sanyo Chemical Industries Ltd., PR-269), and 3.5 kg of a black pigment (Cabot Corporation, Regal 330) instead of the cyan pigment.

(Preparation of Wax Dispersion)

50 g of a paraffin wax (NIPPON SEIRO, HNP10, melting point: 72° C.), 10 g of an anionic surfactant (Dow corning, Dowfax), and 160 g of an ion exchange water were put in a jacket portion, and dispersed for 30 minutes while a homogenizer (Homogenizer, IKA) was heated to 95° C. Then, the dispersion was transferred to a pressure discharge homogenizer (Homogenizer, NIPPON SEIRO), and dispersed for about 20 minutes at 90° C. As a result, a wax dispersion dispersed in a nano size and having a volume-average particle diameter (D50(v)) of 230 nm (measured by Microtrac 252 of Microtrac Inc.) was obtained.

(Preparation of Toner Particles)

Aggregation/Aggregation Freezing/Fusing Process

The polyester resin dispersion, the pigment dispersion, and the wax dispersion were mixed. The mixture was heated to 53° C., and 10 g of an inorganic acid (0.3 M, nitric acid solution) and NaCl, as an agglomerating agent (4.5 wt % based on the mass of the solid contents of the reaction mixture), were added to the mixture. Then, the mixture was homogenized by using an IKA Homogenizer at 10000 rpm for 5 minutes and toner particles were aggregated. In this regard, the mass ratio of the solid contents of the polyester resin dispersion, the pigment dispersion, and the wax dispersion was 85:7:8, and the total solid contents of the reaction mixture was 13 wt %. The pH of the reaction mixture was adjusted to about 5.6 by using a 0.3 M nitric acid solution.

The average size (d50) of the obtained toner particles was 6.3±0.5 μm, and GDDv and GSDp values were 1.3 or less. The average diameter and the particle size distribution were measured by using a Coulter counter (Beckman Coulter).

Fusing was performed by adding a 1N NaOH solution by 70% of the equivalent of the agglomerating agent and stirring the mixture while the temperature for the aggregation was maintained, and then increasing the temperature to 95° C. or higher until circularity reached 0.985 or greater.

Washing and Drying Process

The toner particles were washed several times with ultrapure water until the electrical conductivity of the water after washing reaches 50 μS/cm or less, and then the pH was adjusted to 1.5 by using a 0.3M nitric acid. Then, the toner particles were again washed with ultrapure water until the electrical conductivity of the water after washing reaches 10 μS/cm or less. The wet cake of toner after the washing was dried such that the water content is 1% or less.

### Comparative Example 1

Toner particles were prepared in the same manner as in Example 1, except that 330 g of 2-carboxyethyl acrylate was added instead of 370 g of 2-carboxyethyl acrylate while the latex dispersion was prepared.

### Comparative Example 2

Toner particles were prepared in the same manner as in Example 1, except that 410 g of 2-carboxyethyl acrylate was added instead of 370 g of 2-carboxyethyl acrylate while the latex dispersion was prepared.

### Comparative Example 3

Toner particles were prepared in the same manner as in Example 2, except that 2 g of trimellitic acid was added instead of 3 g of trimellitic acid while the polyester resin dispersion was prepared.

### Comparative Example 4

Toner particles were prepared in the same manner as in Example 2, except that 4 g of trimellitic acid was added instead of 3 g of trimellitic acid while the polyester resin dispersion was prepared.

Evaluation of the toner particles prepared in Examples and Comparative Examples was performed as follows

Evaluation of Chargeability

0.5 g of toner particles prepared in Examples and Comparative Examples, and 9.5 g of a carrier (100 μm, The image society of Japan) were put in a 100 mL wide neck bottle, and left for 6 hours under an NN condition (25° C., 40%). Then, the toner particles and the carrier were mixed at 96 rpm for 60 minutes by using a Turblar mixer (WAB, Switcherland), and then the charge quantity and the charge speed were measured by using a charge quantity measuring device (TB-230, Kyosera Inc.).

Measurement of Dielectric Constant

2 g of toner particles prepared in Examples and Comparative Examples were compression-molded at a pressure of 500 kg/cm² to manufacture a sample having a diameter of 25 mm and a thickness of 2 mm. The dielectric constant was measured at 1 GHz by using an E4991A RF impedance/Material Analyzer (Agilent company).

Measurement of Storage Stability

100 g of toner particles prepared in Examples and Comparative Examples was left under an HH condition (temperature: 35° C., humidity: 50%), and the occurrence of caking was observed every 5 hours. It was evaluated that the non-occurrence of caking after left for 30 hours is OK, the occurrence of caking within 10 hours is X, and the occurrence of caking within 10 to 30 hours is A.

Evaluation of Toner Consumption

An image having a 5% of letter proportion was printed on 500 sheets of A4 paper by a Samsung CLP-510 printer using 9.75 g of toner particles prepared in Examples and Comparative Examples, weights of a developer and a waste toner were measured and compared with the weight of the initial developer to calculate the consumed amount of toner per 500 sheets.

Consumed amount of Toner per 500 sheets=(Weight of initial developer)−[(Weight of developer after printing)−(Weight of waste toner after printing)]

Image Quality Evaluation

An N2 image of JIS-JIS-SCID was printed by a Samsung CLP-510 printer using 9.75 g of toner particles prepared in Examples and Comparative Examples, and was evaluated by the following reference:

◯: Even a detailed portion of an image is viewed clearly

Δ: Slightly low

x: A detailed portion is broken

The evaluation results are shown in Tables 1 to 6.

TABLE 1

| | | | | | Amount | |
|---|---|---|---|---|---|---|
| | | Charge | Charge | | of toner | |
| | Dielectric | quantity | speed | Storage | consump- | Image |
| Example 1 | constant | (−μC/g) | (μC/min) | stability | tion (g) | quality |
| Cyan | 3.42 | 42.27 | 15 | OK | 7.2 | ∘ |
| Yellow | 3.43 | 47.43 | 15 | OK | 7.1 | ∘ |
| Magenta | 3.00 | 47.03 | 16 | OK | 7.4 | ∘ |
| Black | 3.70 | 35.97 | 16 | OK | 7.0 | ∘ |

TABLE 2

| | | | | | Amount | |
|---|---|---|---|---|---|---|
| | | Charge | Charge | | of toner | |
| | Dielectric | quantity | speed | Storage | consump- | Image |
| Example 2 | constant | (−μC/g) | (μC/min) | stability | tion (g) | quality |
| Cyan | 3.33 | 40.79 | 16 | OK | 7.3 | ∘ |
| Yellow | 3.36 | 46.81 | 16 | OK | 7.1 | ∘ |
| Magenta | 3.01 | 42.48 | 15 | OK | 7.3 | ∘ |
| Black | 3.46 | 19.75 | 16 | OK | 7.0 | ∘ |

TABLE 3

| | | | | | Amount | |
|---|---|---|---|---|---|---|
| Com- | | Charge | Charge | | of toner | |
| parative | Dielectric | quantity | speed | Storage | consump- | Image |
| Example 1 | constant | (−μC/g) | (μC/min) | stability | tion (g) | quality |
| Cyan | 4.54 | 33.89 | 12 | OK | 8.0 | Δ |
| Yellow | 4.86 | 36.74 | 10 | OK | 8.1 | x |
| Magenta | 4.92 | 35.41 | 9 | OK | 8.4 | x |
| Black | 5.29 | 30.58 | 9 | OK | 7.9 | Δ |

TABLE 4

| | | | | | Amount | |
|---|---|---|---|---|---|---|
| Com- | | Charge | Charge | | of toner | |
| parative | Dielectric | quantity | speed | Storage | consump- | Image |
| Example 2 | constant | (−μC/g) | (μC/min) | stability | tion (g) | quality |
| Cyan | 1.59 | 61.14 | 15 | x | 7.2 | Δ |
| Yellow | 1.74 | 62.41 | 18 | x | 7.3 | Δ |
| Magenta | 1.82 | 63.57 | 17 | Δ | 7.4 | x |
| Black | 1.91 | 60.39 | 17 | Δ | 7.1 | Δ |

TABLE 5

| | | | | | Amount | |
|---|---|---|---|---|---|---|
| Com- | | Charge | Charge | | of toner | |
| parative | Dielectric | quantity | speed | Storage | consump- | Image |
| Example 3 | constant | (−μC/g) | (μC/min) | stability | tion (g) | quality |
| Cyan | 4.32 | 33.18 | 13 | OK | 7.9 | Δ |
| Yellow | 4.19 | 35.21 | 11 | OK | 7.8 | x |
| Magenta | 4.27 | 36.28 | 10 | OK | 8.1 | x |
| Black | 5.40 | 30.92 | 9 | OK | 7.8 | Δ |

TABLE 6

| | | | | | Amount | |
|---|---|---|---|---|---|---|
| Com- | | Charge | Charge | | of toner | |
| parative | Dielectric | quantity | speed | Storage | consump- | Image |
| Example 4 | constant | (−μC/g) | (μC/min) | stability | tion (g) | quality |
| Cyan | 1.62 | 61.87 | 16 | Δ | 7.3 | Δ |
| Yellow | 1.58 | 61.92 | 19 | x | 7.5 | Δ |
| Magenta | 1.79 | 63.25 | 17 | x | 7.6 | Δ |
| Black | 1.95 | 60.29 | 18 | Δ | 7.2 | Δ |

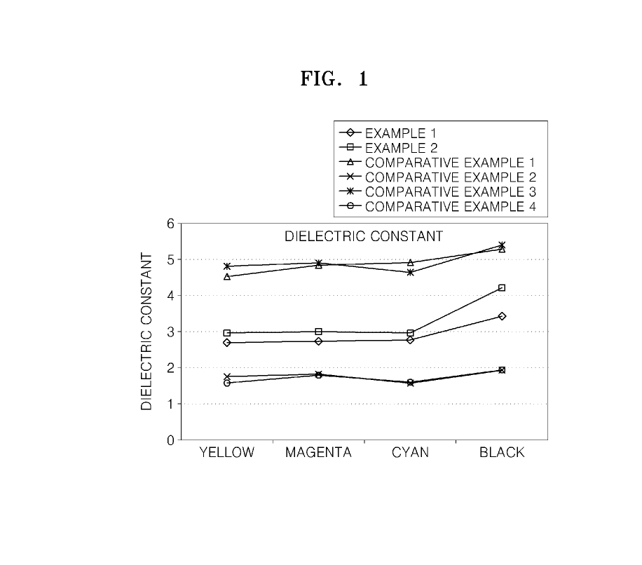

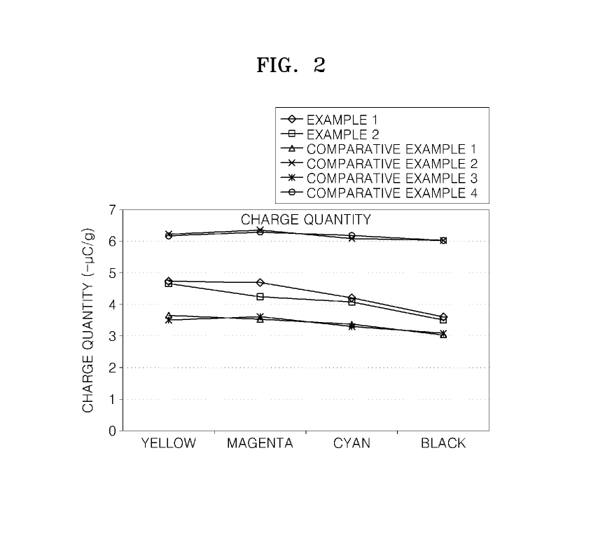

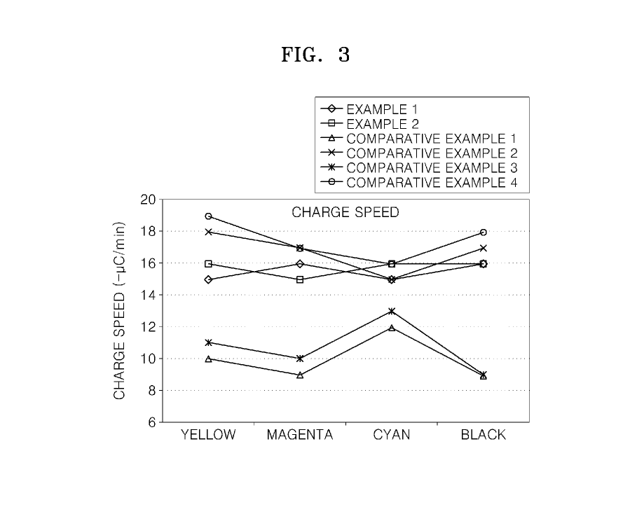

FIG. 1 is a graph showing a dielectric constant of toner particles according to Examples and Comparative Examples, FIG. 2 is a graph showing charge quantity of toner particles according to Examples and Comparative Examples, and FIG. 3 is a graph showing charge speed of toner particles according to Examples and Comparative Examples.

As shown in Tables 1 to 6 and FIGS. 1 to 3, the toner particles of Examples 1 and 2 according to an embodiment of the present invention have superior chargeability and storage stability, are less consumed, and have superior transfer efficiency and image quality.

1. A polymerization toner comprising a binder resin and a colorant, wherein the binder resin has a dielectric constant ranging from about 2.8 to about 3.7.

2. The polymerization toner of claim 1, wherein the polymerization toner is a color toner.

3. The polymerization toner of claim 2, wherein the dielectric constant of the polymerization toner satisfies Equation (1) below:
0.8 B≦dielectric constant≦1.2 B (1)
wherein, B indicates the dielectric constant of the binder resin.

4. The polymerization toner of claim 1, wherein the polymerization toner is a black toner.

5. The polymerization toner of claim 4, wherein the dielectric constant of the polymerization toner satisfies Equation (2) below:
1.1 B≦dielectric constant≦1.4 B (2)
wherein, B indicates the dielectric constant of the binder resin.

6. An electrostatic image developer comprising the polymerization toner of claim 1, and a carrier.

7. A method of forming an electrophotographic image, the method comprising:
adhering toner to a photoreceptor surface with an electrostatic latent image thereon to form a toner image; and
transferring the toner image onto a transfer medium,
wherein the toner is the polymerization toner of claim 1.

8. An electrostatic image developer comprising the polymerization toner of claim 2, and a carrier.

9. An electrostatic image developer comprising the polymerization toner of claim 3, and a carrier.

10. An electrostatic image developer comprising the polymerization toner of claim 4, and a carrier.

11. An electrostatic image developer comprising the polymerization toner of claim 5, and a carrier.

12. A method of forming an electrophotographic image, the method comprising:
adhering toner to a photoreceptor surface with an electrostatic latent image thereon to form a toner image; and
transferring the toner image onto a transfer medium,
wherein the toner is the polymerization toner of claim 2.

13. A method of forming an electrophotographic image, the method comprising:
adhering toner to a photoreceptor surface with an electrostatic latent image thereon to form a toner image; and
transferring the toner image onto a transfer medium,
wherein the toner is the polymerization toner of claim 3.

14. A method of forming an electrophotographic image, the method comprising:
adhering toner to a photoreceptor surface with an electrostatic latent image thereon to form a toner image; and
transferring the toner image onto a transfer medium,
wherein the toner is the polymerization toner of claim 4.

15. A method of forming an electrophotographic image, the method comprising:
adhering toner to a photoreceptor surface with an electrostatic latent image thereon to form a toner image; and
transferring the toner image onto a transfer medium,
wherein the toner is the polymerization toner of claim 5.
